(19) United States
(12) Patent Application Publication
(10) Pub. No.: US 2021/0323431 A1
(43) Pub. Date: Oct. 21, 2021

(54) ELECTRICAL VEHICLE POWER GRID MANAGEMENT SYSTEM AND METHOD

(71) Applicant: CROWD CHARGE LIMITED, Buckinghamshire (GB)

(72) Inventors: Michael POTTER, Buckinghamshire (GB); Ben POTTER, Buckinghamshire (GB)

(21) Appl. No.: 17/272,388

(22) PCT Filed: Aug. 30, 2019
(86) PCT No.: PCT/GB2019/052417

§ 371 Date: Mar. 1, 2021

(30) Foreign Application Priority Data
Aug. 30, 2018 (GB) 1814092.1

(51) Int. Cl. B60L 53/63; B60L 53/65; B60L 53/66; B60L 53/67; B60L 55/00

(52) U.S. Cl. CPC B60L 53/63; B60L 53/65; B60L 2260/52; B60L 53/67; B60L 55/00; B60L 53/66

(57) ABSTRACT

A power grid management system for a power grid to which multiple electrical vehicles and multiple charging points are connected, each charging point including a power supply and a power interface connecting the power supply to an electrical vehicle; the system comprising a load management module that dynamically manages the load on the power grid by taking into account each individual electrical vehicle's characteristics and/or each respective, connected individual charging point's characteristics.

### BACKGROUND OF THE INVENTION

### 1. Field of the Invention

The field of the invention relates to electrical vehicle power grid management systems and methods.

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### 2. Background

Electrical vehicles (EVs) and plug-in hybrid EVs are becoming increasingly popular. They are powered by a battery supplying electricity to the motor and need to be periodically recharged.

The small numbers of EV grid load management solutions that are available tend to distribute the share of load evenly based on the number of chargers connected and operational.

There is a need for an efficient electrical vehicle power grid management solution that would dynamically adapt to the varying parameters of the load management system and that would not only be based on the number of chargers connected and operational.

### SUMMARY OF THE INVENTION

One aspect of the invention is a power grid management system for a power grid to which multiple electrical vehicles and multiple charging points are connected, each charging point including a power supply and a power interface connecting the power supply to an electrical vehicle;
the system comprising a load management module that dynamically manages the load on the power grid by taking into account each individual electrical vehicle's characteristics and/or each respective, connected individual charging point's characteristics.

### BRIEF DESCRIPTION OF THE FIGURES

Aspects of the invention will now be described, by way of example(s), with reference to the following Figures, which each show features of the invention:

FIG. 1 shows a diagram with a plot representing current and power pattern profiles.

FIG. 2 shows a diagram with a plot representing current and power pattern profiles.

FIG. 3 shows a block diagram showing user preference system.

FIG. 4 shows diagram illustrating the modeling and forecasting of electrical vehicle charging.

FIG. 5 shows diagram illustrating the modeling and forecasting of electrical vehicle charging.

FIG. 6 shows a block diagram showing main forecasting and scheduling components.

FIG. 7 shows a block diagram of a typical workflow without and with Telematics.

FIG. 8 is a screenshot of an application running on a device connected to the system.

FIG. 9 is a screenshot of an application running on a device connected to the system.

FIG. 10 is a screenshot of an application running on a device connected to the system.

### DETAILED DESCRIPTION

We now describe an implementation of the invention in the following sections:

Section A: Characterisation Pattern

Section B: Vehicle Driver Interaction

Section C: Modelling and Forecasting of Electric Vehicle Charging

Section D: User Application

Section A: Characterisation Pattern—Determining Scope of Controllability

The ability to use an electric vehicle as a device within a grid load management application depends on a series of factors. The total load and the controllability of that load will typically depend on the vehicle, the chargepoint, the electrical supply to the chargepoint and the cable interconnecting the vehicle to the chargepoint.

Differences in vehicle such as manufacturer, model, vehicle options and vehicle settings applied by the driver will affect the max rate of power demand and potentially when that power demand will occur. Differences in interconnecting cable can restrict the power demand according to the capacity of the cable.

Differences in chargepoint manufacturer, model, features/functionality and the strategy the charger uses for modulating the power available through the implementation of the IEC 6185 standard can affect how power control is executed.

Differences in the electrical supply to the chargepoint are typically configured in the chargepoint in order to restrict the maximum power demand the chargepoint shall apply on the electrical supply.

All these differences have a direct impact on a grid load management systems ability to determine the critical characteristics of a site/vehicle (maximum power that can be drawn, controllability of the power draw in terms of changing the demand up and down and the resolution of the control) and thus the effectiveness of the system cannot be determined accurately.

Furthermore, with the availability of ‘vehicle to grid’ capabilities (vehicle and chargepoint) the same factors apply but in both the demand control and supply control scenarios.

Our system addresses these unknown factors so that the grid load management system can determine the critical characteristics of a site/vehicle and the system can determine the value of the asset within a network of devices when trying to regulate total power demand relative to a series of targets (maximum demand, time of demand).

On connection of an Electric Vehicle to a chargepoint or other power supply point (for example a vehicle may be charged with a portable adaptor cable that connects to a domestic electrical supply socket) our system performs a test control sequence that allows the system to determine the controllability of the vehicle power connection (be it power demand or demand and supply in the case of vehicle to grid applications). This controllability determines the maximum power demand that the vehicle is capable of applying, the resolution of the control in terms of power demand and the ability to halt and schedule the power demand to another period in time.

This allows the system to better predict the value of the individual vehicle/site within a wider network of devices and thus increases the accuracy of the system in terms of predicting whether the system as a whole is under control and with how much precision it has to accurately meet a target.

The system has multiple ‘patterns’ that can be applied to the power demand profile which are used to ascertain the vehicle/cable/chargepoint/supply characteristics.

A pre-determined charging pattern, or sequential power output values, is applied to the charger, or vehicle, in order to determine the type of vehicle and its state, the type of cable, and the type of charger. Different combinations of vehicle type, vehicle state, cable type and charger type respond differently to the pre-determined charging pattern and so these unique combinations can be identified. In this way, the system can detect the unique characteristics of a given charging event and optimise the charging behaviour.

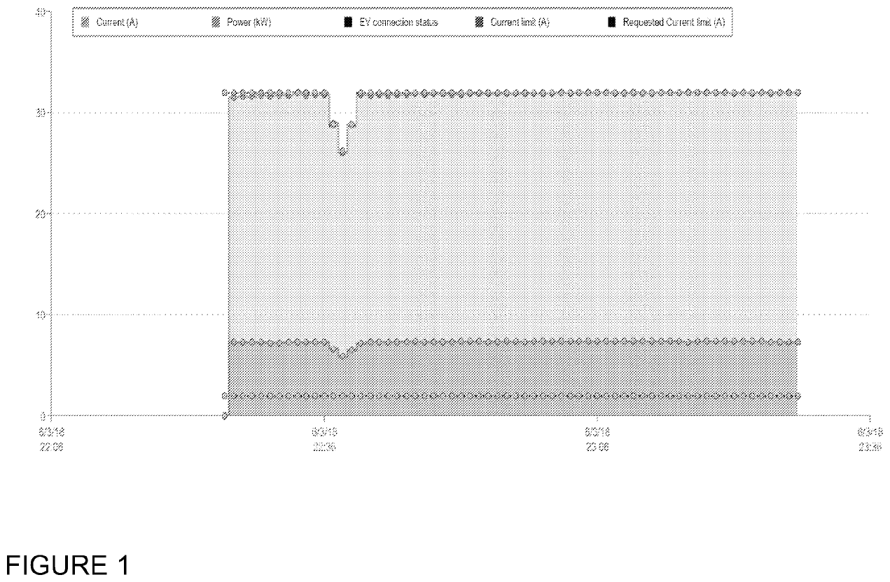

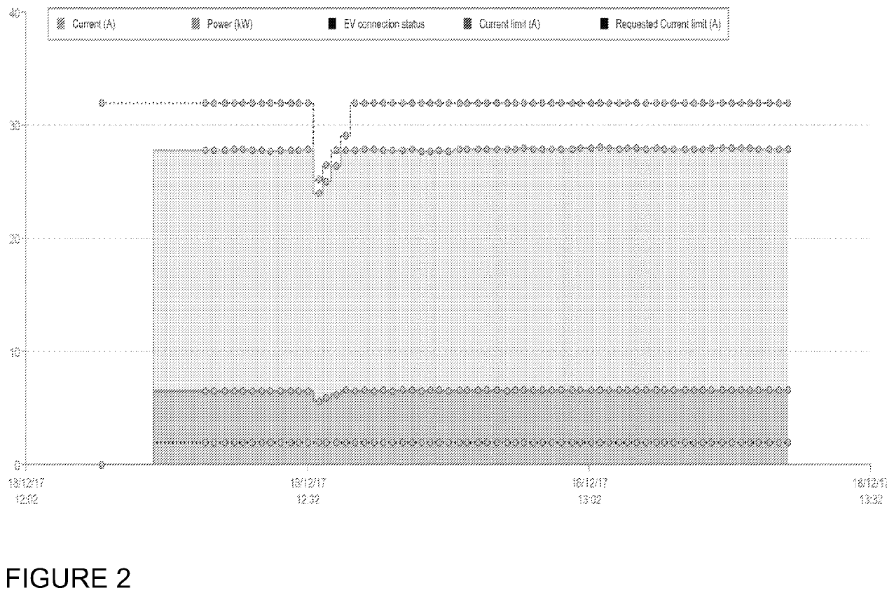

These patterns are either ‘valleys’ or ‘mountain’ profiles. A ‘valley’ profile is where an existing power demand is requested to reduce and then increase in a series of steps so that the system can measure the particular vehicle/cable/chargepoint/supply's controllability for reducing and increasing power demand. Two examples are shown in FIGS. 1 and 2.

A ‘mountain’ profile is where an existing power demand is requested to increase and then decrease in a series of steps so that the system can measure the vehicle/cable/chargepoint/supply's controllability for increasing power demand if the existing power demand appears lower than the expected power demand (A system may hold in record previous power demand for a particular vehicle or chargepoint and look to correlate this with what is existing at a particular event in time).

Section B: Vehicle Driver Interaction—Confirming Required State of Charge of Vehicle and Determining User Flexibility

The ability to use an electric vehicle as a device within a grid load management application depends on profiling the user requirement of the vehicle for transportation. Whilst other techniques ask the user to define when the vehicle is required after a charging session our solution works differently such that users have the ability to prioritise transportation requirements relative to the effect or other paramenters realting to recharging the vehicle e.g. cost, emissions of electricity used, energy mix, ability to purchase electricity from a specific energy supplier.

When the vehicle is going to be charged the user is prompted to decide on the parameters of the charging forthcoming session and whether to use the default or calculated charging scheduled or a user defined requirement. If user defined, the next required vehicle use after the charging session is input in terms of date/time and the amount of energy that is required to fulfill that use when the vehicle is next used is evaluated against the point in time when the user is queried. The user can adjust the required amount of energy they require by indicating actual energy required or distance they require the vehicle to travel before the next charging session. The system is then able to determine the period of time until the vehicle is next expected to be used and the amount of time it will take to transfer the required amount of energy, analyse the cost of energy across that period and identifying the most cost-effective period in which to supply energy from the grid to the vehicle.

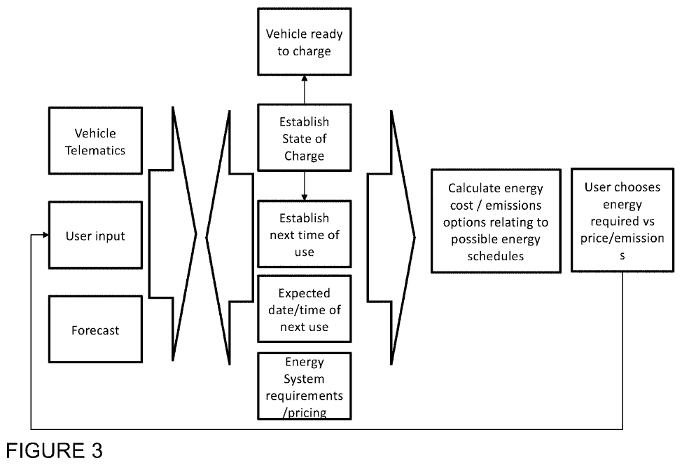

FIG. 3 shows a block diagram showing user preference system.

The more range the user requires in their next journey, the more energy will be required from the grid and as price fluctuates for electricity on a half hourly basis, then generally the shortest period will result in a lowest price (see FIG. 3). As the user increases or decreases their requirement for electricity, the indicated price is calculated and shown so that an informed decision can be made to choose the amount of electricity/price by the user for that next session (see Section D—user application). The amount of electricity/price decision can also be made as a default on price or amount of energy or be automatically adjusted by an intelligent algorithm that learns user behaviour.

Information relating to the future price of electricity can include specific market data, pricing from specific electricity suppliers, weather forecast data relating to renewable generation, electric vehicle user behaviour data which can all be considered by the price algorithm.

This system, rather than attempting to ask the user to input vehicle use times (which is an inherently flawed approach as most users will not have a clear and fixed pattern of use other than obvious journeys such as travel to employment), operates by tracking vehicle use and idle time through a combination of data collected through either telemetry systems on the vehicle or chargepoint communication. The system uses the collected data for one individual and through machine learning algorithms correlates patterns of user behaviour across a wide longitudinal data set and other known user characteristics along with other environmental measurements (climatic real time data, forecast climatic change—used for both vehicle pattern usage and renewable low carbon energy availability) to predict next points of vehicle use.

Each time a driver finishes using their vehicle the system prompts the driver with a prediction of the next time they require the vehicle, the predicted number of miles they will need and expected cost and environmental impact (CO2 creation through energy generation) of having the vehicle ready for that next journey. The driver can then provide feedback to the system that they will require the vehicle sooner or later than the next prediction, they will need more or less range that the prediction or they wish to optimise the cost of environmental impact of their vehicle recharging, aware that it may impact the usability of the vehicle for their transport requirements (as transport evolves it is more likely that users of private vehicles will be incentivised to participate in shared transport solutions such as mobility as a service or autonomous vehicles and short term use vehicles such as cars or bikes).

Section C: Modelling and forecasting of electric vehicle charging

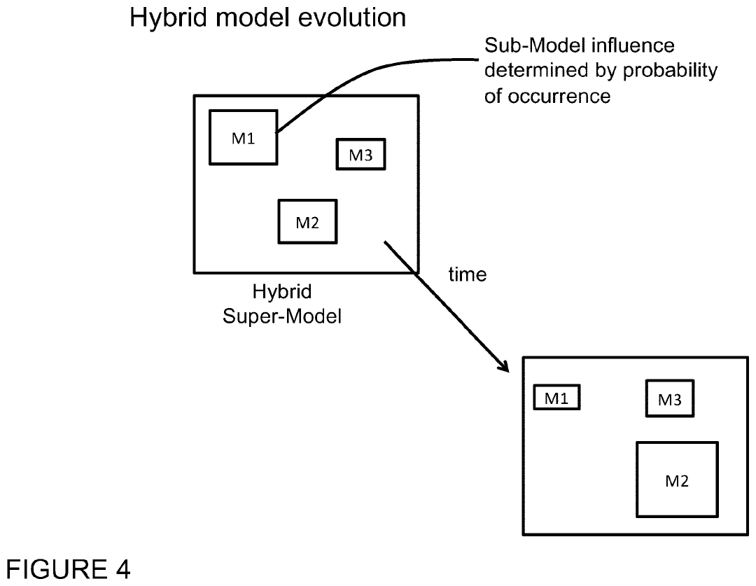

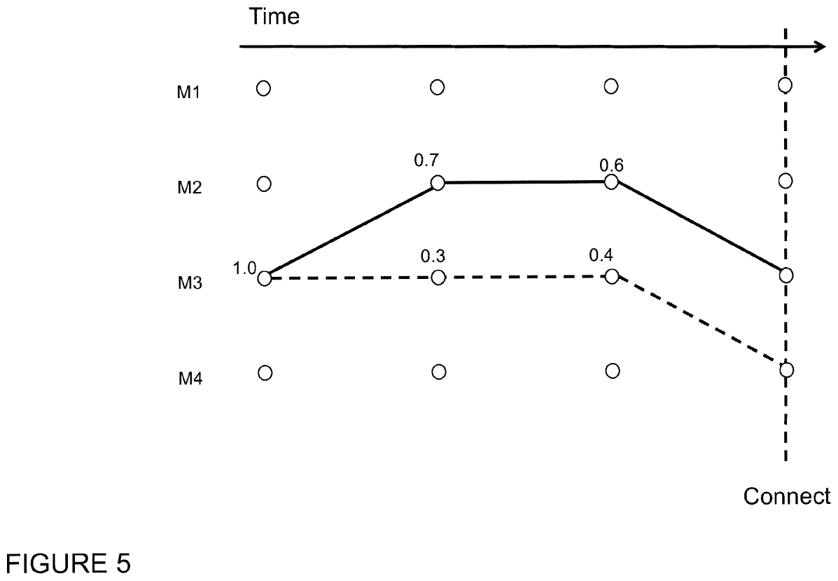

FIGS. 4 and 5 show diagram illustrating the modeling and forecasting of electrical vehicle charging.

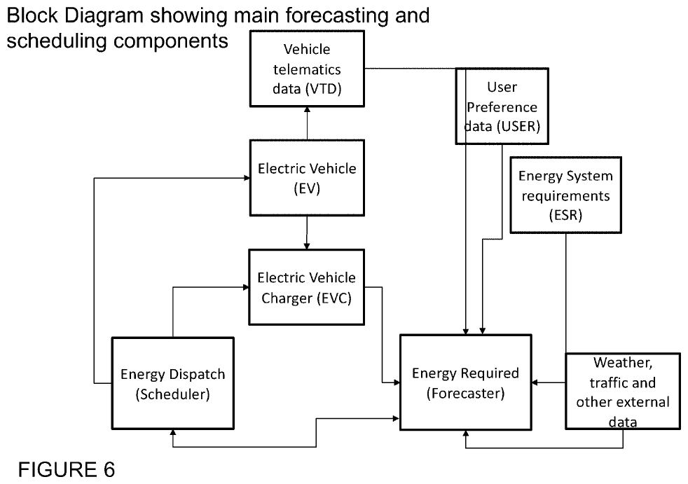

FIG. 6 shows a block diagram showing main forecasting and scheduling components.

Two key events drive the modelling and forecasting of electric vehicle charging requirements: the moment the electric vehicle connects to a V1G or V2G charger (plug-in), and the moment the electric vehicle disconnects (plug-out). Predicting the timestamp of the next plug-in event, T_{IN}, the state-of-charge at plug-in, SoC_{IN}, the timestamp of the following next plug-out, T_{OUT}, and the energy requirements for the next set of journeys before the next plug-in event, E_{NEXT}, are critical to the operation of the charge control system. The Crowd Charge platform uses a matrix of models to predict these variables. A set of model structures, M, are developed that each use a set of parameters, P. Some parameters are common to each model structure and some parameters are unique to each model structure. A combination of one model structure with one set of parameters forms a complete model, Mᵢ. Each complete model is used to represent the usage behaviour of a specific combination, Sₚ, of electric vehicle, EVₖ, driver, Dₘ, and charger, Cₙ i.e. Sₚ contains EV₁, D₁, C₁. As such, two different drivers with the same electric vehicle would be represented by two different complete models i.e. M₁ and M₂. More than one complete model can be used to represent the same unique combination of electric vehicle, driver and charger, with the accuracy and efficacy of each model varying with time and parameter values. For example, models M₁₁ and M₂₁ could both be used to represent the same combination of vehicle, driver and charger, S₁, but would have different structures and parameters. As such a family of models would exist to predict the usage behaviour of each combination of vehicle, driver and charger.

The Crowd Charge system selects the model that is most likely to provide the most accurate estimate of future usage behaviour, with this selection constantly being updated as new information becomes available such as from telematics, mobile applications, or data from the charger. The determination of which model is most likely to provide the most accurate estimate is based on a probabilistic analysis of historical data combined with trajectory tracking of model predictions in real-time.

In order to predict when a charging event will occur with a specific vehicle and charger, a probabilistic analysis of historical data combined with trajectory tracking of model predictions of real-time parameters is used. For example, three behavioural models may be chosen as the most candidates to represent the behaviour of a specific user, vehicle and charger, in order to predict when a charging event will next occur along with the characteristics of that charging event. The system may not know which of the these three behavioural models will ultimately most closely represent the actual behaviour, and so will monitor key parameters linked to these models in order to determine a real-time probability of occurrence for each of the models. As time progresses, these probabilities will shift until one model emerges as the most likely and estimates collapse onto actual behaviour. The shifting probabilities of each model are considered a trajectory, over time, that point towards a future most likely outcome.

To provide predictions of the usage profile of groups of chargers, vehicles, or drivers, the Crowd Charge system combines all the sets of models into a larger set of sets, or matrix of models. The influence of each member of this matrix of models varies with time, and parameters, and the flow of new information. This matrix of models is used to determine and predict aggregate behaviour of the large groups of electric vehicles, drivers and chargers, and specifically to determine T_{IN}, SoC_{IN}, and T_{OUT} for a specific upcoming charging event.

Section D: User Application

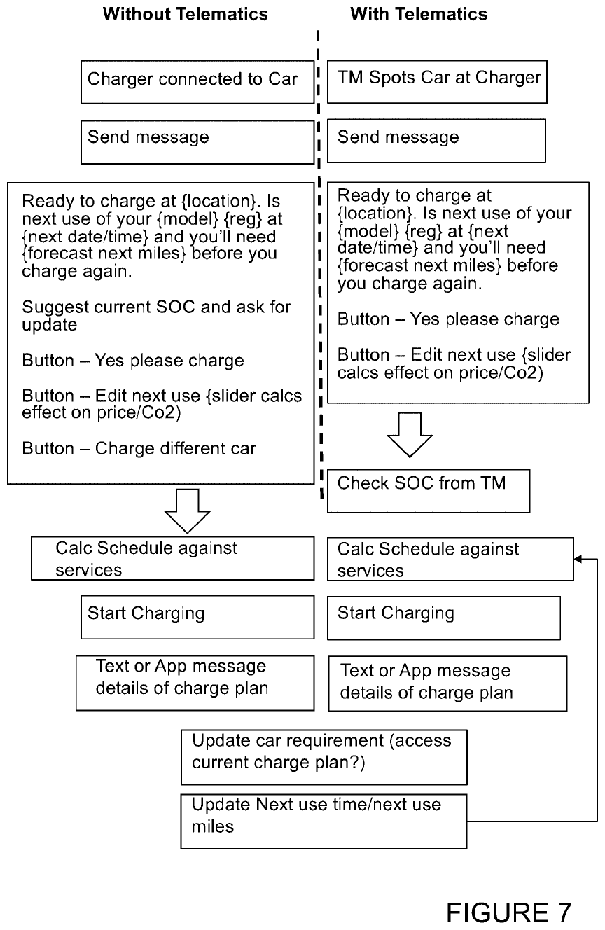

FIG. 7 shows a block diagram of a typical workflow without and with Telematics.

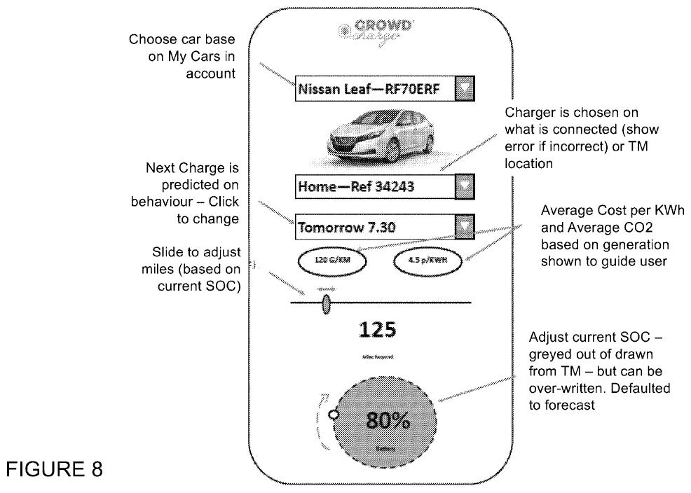

FIG. 8 is a screenshot of an application running on a device connected to the system. The end user is able to select a car based on the pre-registered card. The charger is then chosen based on what is connected or on the telematics location. The next charge is then predicted based on behaviour and displayed to the end-user. Alternatively, the end-user can manually select or change the next charge date and time. The average cost per hour and average CO2 based on generation is displayed to guide the end-user. A slide to adjust miles based on the current SOC is also shown. The current SOC is also displayed.

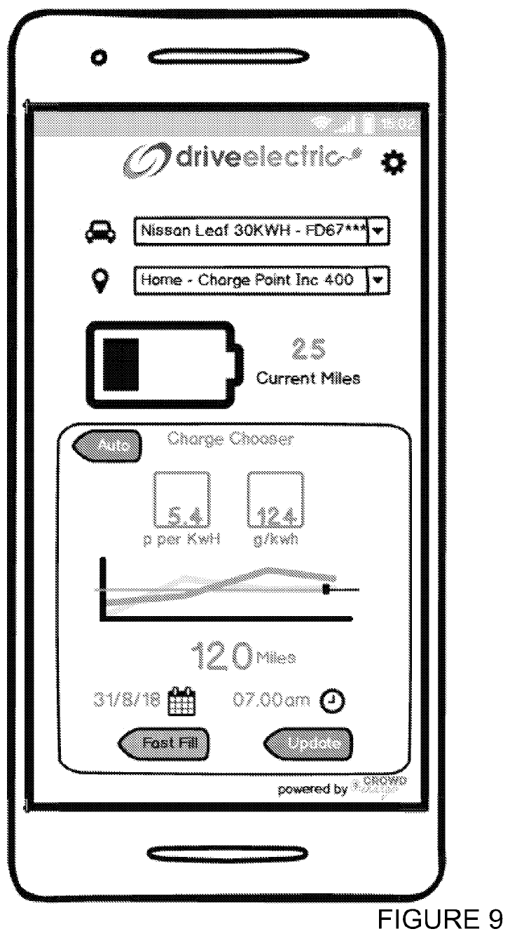

FIG. 9 is a screenshot of another example of application running on a device connected to the system.

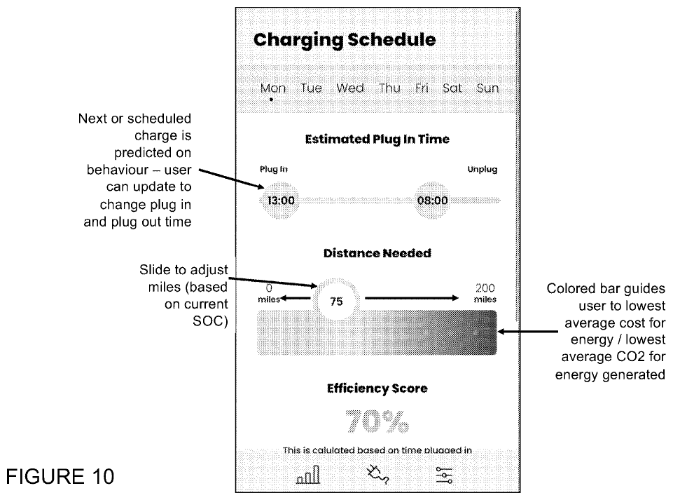

FIG. 10 is a screenshot of an application running on a device connected to the system in which a charging schedule is displayed. The next or scheduled charge is predicted on behaviour and displayed to the end-user. Alternatively, the end-user can updated to change the plug in and plug out time of a next or scheduled charge. A colour graduated guide bar is also displayed that shows how to choose the optimum amount of charge to lower cost or CO2. The graduation of this bar can change based on any or a combination of the following, but not limited to:
Any changes in plug in and plug out time;
Any changes in the relevant energy pricing;
Any changes in total current for a group of vehicles where the total current is also being managed.

### APPENDIX—KEY FEATURES

This section summarises the most important high-level features (A->F); an implementation of the invention may include one or more of these high-level features, or any combination of any of these. Note that each high-level feature is therefore potentially a stand-alone invention and may be combined with any one or more other high-level feature or features or any of the ‘optional’ features.

A. Dynamic Load Management

A power grid management system for a power grid to which multiple electrical vehicles and multiple charging points are connected, each charging point including a power supply and a power interface connecting the power supply to an electrical vehicle;
the system comprising a load management module that dynamically manages the load on the power grid by taking into account each individual electrical vehicle's characteristics and/or each respective, connected individual charging point's characteristics.

A power grid management system for a power grid to which multiple electrical vehicles and multiple charging points are connected, each charging point including a power supply and a power interface connecting the power supply to an electrical vehicle;
the system comprising a load management module that dynamically evaluates the value or utility to the power grid of an electrical vehicle by taking into account each individual electrical vehicle's characteristics and/or each respective, connected individual charging point's characteristics.

A power grid management system for a power grid to which multiple electrical vehicles and multiple charging points are connected, each charging point including a power supply and a power interface connecting the power supply to an electrical vehicle;
the system comprising a load management module that performs a test control sequence that allows the system to determine the controllability of the vehicle power connection between a specific charging point and a specific vehicle.

A power grid management system for a power grid to which multiple electrical vehicles and multiple charging points are connected, each charging point including a power supply and a power interface connecting the power supply to an electrical vehicle; the system comprising a load management module that applies a charging pattern or sequence of power output values to a charging station or vehicle and detects characteristics of the behavior of the charging station or vehicle to enable future charging to be optimised.

Optional:
The load management module dynamically manages the load on the power grid by taking into account the power demand and supply at the charging points
Electrical vehicle characteristics include: vehicle manufacturer, model, vehicle options, maximum speed, history of user behaviour, battery characteristics.
Charging point characteristics include: charging point manufacturer, model, features/functionality, power modulation techniques, type of power to vehicle interface, geographical position within the grid.
Load management module calculates maximum power that can be drawn from each charging point, and the maximum power that can be supplied to the vehicle.
Load management module manages in real time the power demand and supply at the plurality of charging points.
Power interface is a cable.
Power interface is a wireless power interface.
When an electrical vehicle accesses a charging point, the system detects the electrical vehicle characteristics in real time.
The system determines a unique charging pattern or model as a function of the detected characteristics.
A charging point is a dedicated electrical vehicle charging station, or a domestic electrical supply socket

B. Dynamic Load Management Including Parameters of a Next Charging Event

A power grid management system for a power grid to which multiple electrical vehicles and multiple charging points are connected, each charging point including a power supply and a power interface connecting the power supply to an electrical vehicle; the system comprising a load management module that receives end-user requirements for a charging session, apart from or in addition to the time by which the vehicle is to be ready.

A power grid management system for a power grid to which multiple electrical vehicles and multiple charging points are connected, each charging point including a power supply and a power interface connecting the power supply to an electrical vehicle;
the system comprising a load management module that presents to an end-user a matrix or grid or list of the prices of electricity required, as a function of the distance the end-user wishes to travel, or another parameter that is related to the quantity of electricity required.

Optional:
End-user requirements include one or more of the following: costs, emissions associated with the electricity used, carbon associated with the electricity used, energy mix, specific source or type of energy from a set of different sources or types, specific supplier of energy, from a set of different suppliers.
The end-user is able to set priorities between different end-user requirements.
Load management module calculates the optimum cost-effective time and/or period in which to supply power from the grid to the vehicle, taking into account the end-user requirements.
Load management module calculates the optimum time and/or period in which to supply power from the grid to the vehicle based on environmental impact, taking into account end-user requirements.
Parameters of the next charging session include: time or date when charging is needed, required distance or required power.
Load management module receives and records history of user behaviour.
Load management module tracks and records user requirements and user behaviour.
Machine learning techniques are used to predict future vehicle use.
End-user requirements are received via an application running on a connected device.

C. Prediction of Next Use

A power grid management system for a power grid to which multiple electrical vehicles and multiple charging points are connected, each charging point including a power supply and a power interface connecting the power supply to an electrical vehicle; the system comprising a load management module that predicts to the end-user one or more of the following: when that end-user will next require the vehicle, the number of miles they will need and the expected cost and environmental impact of having the vehicle ready for that next journey.

Optional:
environmental impact takes into account current weather data and weather forecast data.
Load management predicts when that end-user will next require the vehicle by tracking vehicle use and idle time through a combination of data collected through either telemetry systems on the vehicle or charging point communication.
Load management predicts when that end-user will next require the vehicle by machine learning algorithms across a wide longitudinal data set
The driver provides feedback to the system: that they will require the vehicle sooner or later than the next prediction, they will need more or less range that the prediction or they wish to optimise the cost or environmental impact of their vehicle recharging
System outputs expected cost to the end-user.
System outputs expected environment impact to the end-user.
System outputs other available options, such as shared transport solutions, bike or public transport.

D. Prediction of a Next Charging Event

A power grid management system for a power grid to which multiple electrical vehicles and multiple charging points are connected, each charging point including a power supply and a power interface connecting the power supply to an electrical vehicle; the system comprising a forecasting module that (a) forecasts an electrical vehicle charging event based on a probabilistic model, in which the probabilistic model is derived from an analysis of historical charging-related data.

Optional:
The probabilistic model is refined in real-time through trajectory tracking of model predictions
Charging related data includes: electric vehicle characteristics, end-user profile, and charging point characteristics.
Forecasting module tracks and records each time an electrical vehicle is plugged in and plugged out, in order to predict the next plug-in and plug-out event.
Forecasting module tracks and records the state of charge at plugged in and plugged out events.
Forecasting module predicts the energy requirement of the next journey.
Forecasting module outputs the parameters for an optimised charging profile associated with the predicted next journey.
Forecasting module predicts aggregate behaviour of a large group of electrical vehicles.

E. Storing Unique Charging Patterns

A database storing electrical vehicle charging patterns as defined above.

Optional:
Database is categorised into different groups, in which the groups are based on end-user profiles, electrical vehicle characteristics and charging point characteristics.

F. Automatic Detection of EV Characteristics

Electrical vehicle charging system in which the system automatically detects an electrical vehicle and its characteristics when it is plugged in, forecasts the next journey required by the end-user and outputs to the end-user an optimised next charging session parameters associated with the forecasted journey.

Optional:
The optimised next charging session parameters to the end-user are outputted on an application running on a connected device.

Note

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A power grid management system for a power grid to which multiple electrical vehicles and multiple charging points are connected, each charging point including a power supply and a power interface connecting the power supply to an electrical vehicle;
the system comprising a load management module that is configured to dynamically manage the load on the power grid by taking into account each individual electrical vehicle's characteristics and each respective, connected individual charging point's characteristics, and in which the load management module is further configured to calculate the optimum time and/or period in which to supply power from the grid to each connected vehicle based on minimizing environmental impact.

2. The system of claim 1, in which the electrical vehicle characteristics include: vehicle manufacturer, model, vehicle options, maximum speed, history of user behaviour, battery characteristics.

3. The System of claim 1, in which the charging point characteristics include: charging point manufacturer, model, features/functionality, power modulation techniques, type of power to vehicle interface, geographical position within the grid.

4. The system of claim 1, in which the load management module calculates maximum power that can be drawn from each charging point, and the maximum power that can be supplied to each connected the vehicle.

5. The system of claim 1, in which the load management module manages in real time the power demand and supply at the plurality of charging points.

6. The system of claim 1, in which the power interface is a cable.

7. The system of claim 1, in which the power interface is a wireless power interface.

8. The system of claim 1, in which when an electrical vehicle accesses a charging point, the system detects the electrical vehicle characteristics in real time when the electrical vehicle has plugged in the charging point.

9. The system of claim 1, in which the system determines a unique charging pattern or model as a function of detected electrical vehicle's characteristics and/or detected charging point's characteristics.

10. The system of claim 1, in which the load management module receives end-user requirements for each electrical vehicle including the parameters of a next charging session.

11. The system of claim 10, in which the load management module calculates the optimum cost-effective period in which to supply power from the grid to the vehicle, taking into account the end-user requirements.

12. The system of claim 10, in which the load management module calculates the optimum time and/or period in which to supply power from the grid to the vehicle based on environmental impact, taking into account the end-user requirements.

13. The system of claim 10 or 12, in which the parameters of the next charging session include: time or date when charging is needed, required distance or required power.

14. The system of claim 1, in which the load management module receives and records history of user behaviour.

15. The system of claim 1, in which the system tracks and records user requirements and user behaviour.

16. The system of claim 1, in which the system uses machine learning techniques to predict future vehicle use.

17. The system of claim 1, in which end-user requirements are received via an application running on a connected device.

18. The system of claim 1, in which the load management module predicts environmental impact of a next scheduled journey by taking into account current weather data and weather forecast data.

19. The system of claim 1, in which the system outputs expected cost to an end-user.

20. The system of claim 1, in which the system outputs expected environmental impact to the end-user.

21. The system of claim 1, in which the system outputs other available options available to the end-user for a next scheduled or predicted journey, such as shared transport solutions, bike or public transport.

22. The system of claim 1, in which the system is configured to forecast an electrical vehicle charging event based on a probabilistic model.

23. The system of claim 22, in which the probabilistic model takes into account charging related data, such as: electric vehicle characteristics, end-user profile, and charging point characteristics.

24. The system of claim 22, in which the probabilistic model tracks and records each time an electrical vehicle is plugged in and plugged out, in order to predict next plug-in and plug-out event.

25. The system of claim 22, in which the probabilistic model tracks and records the state of charge at plugged in and plugged out events.

26. The system of claim 22, in which the probabilistic model predicts the energy requirement of a next journey.

27. The system of claim 22, in which the probabilistic model outputs the parameters for an optimised charging profile associated with a predicted next journey.

28. The system of claim 22, in which the probabilistic model predicts aggregate behaviour of a large group of electrical vehicles.

29. A method for power grid management in which multiple electrical vehicles and multiple charging points are connected to a power grid, each charging point including a power supply and a power interface connecting the power supply to an electrical vehicle;
the method comprising dynamically managing the load on the power grid via a load management module by taking into account each individual electrical vehicle's characteristics and each individual charging point's characteristics, in which the load management module is further configured to calculate the optimum time and/or period in which to supply power from the grid to each connected vehicle based on minimizing environmental impact.
